(19) United States
(12) Patent Application Publication
(10) Pub. No.: US 2016/0189554 A1
(43) Pub. Date: Jun. 30, 2016

(54) EDUCATION SERVICE SYSTEM

(71) Applicant: ELECTRONICS AND TELECOMMUNICATIONS RESEARCH INSTITUTE, Daejeon (KR)

(72) Inventors: Ji Yeon KIM, Daejeon (KR); Noh Sam PARK, Daejeon (KR); Hyun Woo OH, Daejeon (KR); Hoon Ki LEE, Daejeon (KR); Jong Hyun JANG, Daejeon (KR)

(21) Appl. No.: 14/983,457

(22) Filed: Dec. 29, 2015

(30) Foreign Application Priority Data
Dec. 30, 2014 (KR) 10-2014-0194098

(51) Int. Cl. G09B 5/02; H04W 4/00; H04L 29/08

(52) U.S. Cl. CPC G09B 5/02; H04L 67/306; H04L 67/22; H04W 4/005

(57) ABSTRACT

Provided herein is an education service system including a user device, which reproduces provided learning content and generates device input information through user input; a learning situation recognition unit, which calculates user state information based on the device input information and selects recommended content depending on the user state information, and a learning content providing unit, which provides learning content corresponding to the recommended content from among a plurality of pieces of pre-stored learning content to the user device.

### CROSS-REFERENCE TO RELATED APPLICATION

The present application claims priority to Korean patent application number 10-2014-0194098 filed on Dec. 30, 2014, the entire disclosure of which is incorporated herein in its entirety by reference.

### BACKGROUND

1. Field of Invention

Various embodiments of the present disclosure relate to an education service system, and more particularly, to an education service system capable of providing an appropriate service for education based on recognition of learning patterns of a user by determining the state and situation of the user using ambient sensors and device information, in order to respond to the situation in which smart remote education services have widely proliferated with a concomitant decrease in concentration levels and increase in smart device addiction due to content that is unnecessary or merely entertaining, i.e. due to one-sided learning.

2. Description of Related Art

As smart devices have rapidly proliferated in recent years due to the advantages thereof, namely that they provide accessibility anytime and anywhere and may be used to obtain a wealth of information, services using the smart device have diversified, and particularly, smart remote education service using smart devices has arisen.

According to reports regarding the use of smartphones published in major media, statistics indicate that the average time that people of all generations spend using smartphones is 2 hours or more, and that teenagers spend more time than other generations. Services which are mainly used include entertainment applications such as games, photo editing tools, SNS services such as Kakao talk, messaging, lifestyle information, etc. There is growing concern that teenagers, who spend their leisure time with smartphones rather than doing active sports, are more prone to anxiety and depression and may be cut off from the outside world, that is, that the incidence of so-called ‘hikikomori’ type social misfits is increasing.

In order to overcome the disadvantages of smartphones, namely that students do not concentrate on class but only acquire fragmentary knowledge, at some schools personal smartphones are confiscated from students when they arrive at school. Such regulations may be enforceable at school, but at home it is expected to be difficult to restrict the service through personal willpower alone. The results of an investigation jointly conducted by the Ministry of Gender Equality & Family and the Korean Society for Journalism and Communication Studies indicated that among students who attempted to reduce time spent using smartphones, 41.2% failed, suggesting that it will be difficult to continuously suppress the use of the smartphone.

In spite of these disadvantages, smart education service using smart devices is expanding since it is a pragmatic way to allow users to learn extensive materials and textbook content. Service is being provided through EduNet, which is a wired education network in schools, and at-home remote cyber education service provided through specialized service companies is expanding.

Accordingly, the present disclosure provides a safer smart remote education service based on information about the state of the user, determined using sensing devices installed in homes and user device input information.

### SUMMARY

Various embodiments of the present disclosure are directed to assist in utilizing a smart device more efficiently and safely by using information acquired by sensing devices installed in homes, the smart device used by a user, and the like.

Furthermore, various embodiments of the present disclosure are directed to provide an appropriate service to the user by acquiring learning pattern information of the user by using information acquired through the smart device.

Furthermore, various embodiments of the present disclosure are directed to reduce adverse effects, such as distraction of the user and resistance to learning caused by the situation in which, although remote cyber education is actively provided, the education content is provided in a one-sided manner while disregarding the degree of concentration of the user and the time that the user spends studying.

Furthermore, various embodiments of the present disclosure are directed to solve the problem whereby the user does not follow the learning schedule, but concentrates on content that is merely entertaining in an environment in which the user is able to access extensive content.

Furthermore, various embodiments of the present disclosure are directed to provide education to alleviate and prevent the social maladjustment phenomenon, which is an adverse effect of the utilization of smart devices.

One embodiment of the present disclosure provides an education service system including a user device, which reproduces provided learning content and generates device input information through user input, a learning situation recognition unit, which calculates user state information based on the device input information and selects recommended content depending on the user state information, and a learning content providing unit, which provides learning content corresponding to the recommended content from among a plurality of pieces of pre-stored learning content to the user device.

The user state information may include the reaction speed of the user with respect to a response/selection speed and the pace at which the educational content is learned. The plurality of pieces of learning content may include metadata classified depending on the learning difficulty level and the category, and the recommended content may be learning content reproduced subsequent to the currently reproduced learning content in the user device.

The learning situation recognition unit may continue to reproduce the currently reproduced learning content or learning content having the same difficulty level as the currently reproduced learning content when the reaction speed of the user is within a reference range, may select learning content having a higher difficulty level than the currently reproduced learning content as the recommended content when the reaction speed of the user is above the reference range, and may select learning content having a lower difficulty level than the currently reproduced learning content as the recommended content when the reaction speed of the user is below the reference range.

The learning content providing unit may introduce at least one piece of learning content corresponding to the recommended content to the user and provide at least one piece of learning content, selected by the user, to the user device.

The education service system may further include an input information recording unit in which the device input information and sensing information at the time of reproducing the learning content are collected, in which the user device may include a sensing device, which outputs sensing information relating to the environment surrounding the user.

The learning situation recognition unit may calculate the user state information based on the device input information and the sensing information and select the recommended content corresponding to the user state information.

The user device may include an imaging unit, and the user state information may further include the extent to which a user watches a screen, determined using the imaging unit.

The learning situation recognition unit may continue to reproduce the currently reproduced learning content or learning content in the same category as the currently reproduced learning content when the extent to which the user watches the screen is above a reference value, and may select learning content in a different category from that of the currently reproduced learning content as the recommended value when the extent to which the user watches the screen is below the reference value.

The education service system may further include a device control unit controlling a reality device to execute a reality-check operation for attracting the attention of a user when the extent to which the user watches the screen is below the reference value, the user device including the reality device for stimulating the user. The reality-check operation may be an operation of generating at least one of moving images indicating a warning, sound, wind, and vibration.

The device control unit may request the learning content providing unit to stop providing the currently provided learning content and provide the recommended content when the reaction speed of the user is below the reference range or when the extent to which the user watches the screen is below the reference value.

The education service system may further include a profile management unit recording and updating profile information on content characteristics, the content preference of the user, the learning history of the user, and the device operation. The learning situation recognition unit may select learning content having high correlation with the learning content and high content preference of the user as the recommended content with reference to the profile information at the time of selecting the recommended content.

The user device may include a smart device including a display unit, an imaging unit, and a user interface unit, respectively. The sensing device may include at least one of a temperature sensor, a humidity sensor, an illuminance sensor, an infrared radiation (IR) sensor, a magnetic sensor, a weight sensor, and a voice recognition sensor which are provided near the user. The reality device may include an electric fan, provided close to the user, and a smartphone.

The present disclosure provides the smart remote education service more safely and efficiently based on the user state information determined by utilizing the sensing device and the smart device.

Furthermore, the present disclosure provides education content customized for the user, not one-sided education content, by recommending the content based on the level of the user.

### BRIEF DESCRIPTION OF THE DRAWINGS

Example embodiments will now be described more fully hereinafter with reference to the accompanying drawings; however, they may be embodied in different forms and should not be construed as being limited to the embodiments set forth herein. Rather, these embodiments are provided so that this disclosure will be thorough and complete, and will fully convey the scope of the example embodiments to those skilled in the art.

FIG. 1 is a schematic configuration diagram of an education service system according to an embodiment of the present disclosure;

FIG. 2 is a detailed configuration diagram of the education service system of FIG. 1; and

FIGS. 3 and 4 are control flowcharts of the education service system according to an embodiment of the present disclosure.

### DETAILED DESCRIPTION

Hereinafter, embodiments of the present disclosure will be described in more detail with reference to the accompanying drawings.

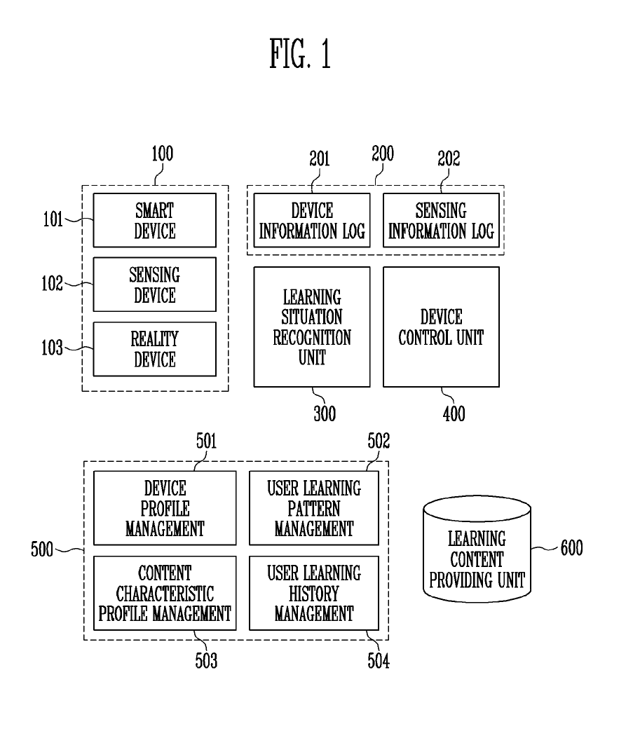

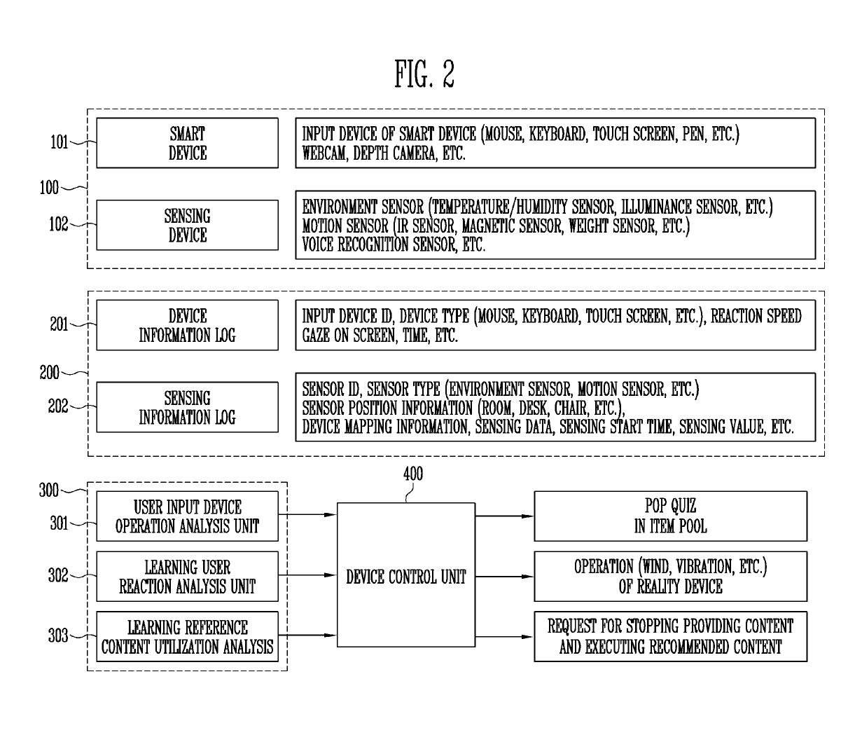

FIG. 1 is a schematic configuration diagram of an education service system according to an embodiment of the present disclosure, and FIG. 2 is a detailed configuration diagram of the education service system of FIG. 1.

Referring to FIGS. 1 and 2, an education service system according to an embodiment of the present disclosure may include a user device 100, an input information recording unit 200, a learning situation recognition unit 300, a device control unit 400, a profile management unit 500, and a learning content providing unit 600.

The user device 100 reproduces provided learning content and generates device input information through user input. According to an embodiment, the user device 100 may include a smart device 101, a sensing device 102 and a reality device 103.

The smart device 101, which serves to determine the reaction of the user depending on the reproduced content, acquires the content, the reaction speed via an input device, the duration for which the user watches a screen, and the like to be used as input information based on which the learning situation recognition unit 300 makes a determination. For example, the smart device 101 may include an IPTV, a desktop computer, a notebook computer, a tablet PC, and a smartphone, each including a display unit, an imaging unit, and a user interface unit. The display unit is a display for displaying an image, the imaging unit is a camera for acquiring user image information, such as a depth camera or a webcam, and the user interface unit is an input device, which is a means for the user to directly input data, such as a mouse, a keyboard, a touch screen, a pen, and the like.

The sensing device 102 outputs sensing information on the environment surrounding the user. The sensing information, which serves to determine the surrounding environment and the reactive motions of the user while the content is being reproduced, is used to the determine reaction information of the user based on a motion sensor depending on the season, the time of day, illuminance, and the like, which comprise the surrounding environment information. For example, the sensing device 102 may be configured to include an environment sensor (a temperature/humidity sensor, an illuminance sensor, etc.) for detecting the environment surrounding the user, a motion sensor (an infrared ray (IR) sensor, a magnetic sensor, a weight sensor, etc.), and a voice recognition sensor.

The reality device 103, which functions to stimulate the user, may include an electric fan provided near the user, and a smartphone.

The input information recording unit 200 collects the device input information and the sensing information at the time of reproducing the learning content. According to an embodiment, the input information recording unit 200 is configured to include a device information log 201 and a sensing information log 202, the device information log 201 may include an input device ID, a device type, device state information, a reaction speed, an extent of watching the screen, a measurement time, and the like, and the sensing information log 202 may include a sensor ID, a sensor type, sensor position information, device mapping information, a sensing date, a sensing start time, and the like. Describing an example of the device information log 201, the input information may be processed such that the learning situation recognition unit 300 may make a determination on the user state information based on the difference between the time at which the user makes an input through the mouse of the smart device 101 when the learning content starts and the time at which the user is required by the content to make an input. Further, the result of the process of determining the time during which the user watches the content using the camera and the motion sensor may be stored in the log and utilized for a user learning pattern management profile 502 of the profile management unit 500.

The learning situation recognition unit 300 may calculate the user state information based on the device input information and the sensing information and select the recommended content depending on the user state information. The user state information may include the reaction speed of the user with respect to a response/selection speed and the pace at which the content is learned. Further, the user state information may further include the extent to which the user watches the screen, determined using the imaging unit. That is, the learning situation recognition unit 300 selects recommended content corresponding to the reaction speed of the user and the degree of the gaze on the screen. In this case, the learning situation recognition unit 300 may select learning content that has both a high correlation with the learning content and a high content preference of the user as the recommended content, with reference to the profile information stored in the profile management unit 500.

According to an embodiment, the learning situation recognition unit 300 is configured to include a user input device operation analysis unit 301, a learning user reaction analysis unit 302, and a learning content utilization analysis unit 303, and may transfer the result of calculating the user state information to the device control unit 400. The learning situation recognition unit 300 performs a process of recognizing the user state information by using the profile information recorded in the user device 100 and the profile management unit 500 and transfers the user state information to the device control unit 400 to perform an operation mapped to the user state information. For example, the learning situation recognition unit 300 determines the user state information based on the input information and sensing information input from the user device 100, such as a frequency of motion of the user while learning, a mouse click reaction speed, a keyboard input time, an extent of watching the screen, eyelid motion, head movement, and the user learning pattern management profile 502 and user learning history management profile 504 information, stored in the profile management unit 500, and transfers the determination result to the device control unit 400.

The device control unit 400 may request the learning content providing unit 600 to stop the content or provide the recommended content depending on the user state information, or may control the operation of the user device 100. In detail, the device control unit 400 may request the learning content providing unit 600 to stop providing the currently provided learning content and provide the recommended content when the reaction speed of the user is below the reference range or when the extent to which the user watches the screen is below the reference value. Further, the device control unit 400 may control the smart device 101 and the reality device 103 to execute the reality-check operation to attract the attention of the user when the extent to which the user watches the screen falls below the reference value. Here, the reality-check operation may be an operation of generating at least one of moving images providing a warning, sound, wind, and vibration.

The device control unit 400 enables appropriate device control for the user based on the device input information, the sensing information, and the profile information stored in the input information recording unit 200 and the profile management unit 500 depending on the user state information input from the learning situation recognition unit 300. For example, in the case in which a result message indicating that the user is not concentrating when studying content similar to content that the user has studied in the past is transferred from the learning situation recognition unit 300, the device control unit 400 checks the environment sensor information via the sensing device 102, and when the current state is mapped to a problem which relates to the user learning environment, controls the related device.

Further, the device control unit 400 may control the display of the smart device 101 depending on the device utilization information preferred by the user at the time of learning each piece of content by utilizing the profile information recorded in the profile management unit 500. For example, when a document or moving image, a chat message, camera information, a push message, and the like are received as input, the document or moving image is displayed on a large screen, and the chat message, the push message, and the camera information of the opposite party are displayed on a personal terminal. When the content selected by the user includes a moving image and text, the media information is displayed depending on the user preference with respect to the device utilized for each piece of learning content, that is, the media information is not one-sidedly provided to the device having a large display screen, but is provided in a manner such that a text file is displayed on a device having a large display screen, and the face of an opposite party (camera information), a chat message, and the like are displayed on the auxiliary device based on the user preference and utilization analysis, such that the extent of control of the device by the user is reduced while studying.

The profile management unit 500 records and updates profile information on content characteristics, the user's content preferences, the learning history of the user, and device operation. According to an embodiment, the profile management unit may be divided into a device profile management 501, the learning pattern management profile 502, a content characteristic profile management 503, and the user learning history management profile 504.

The device profile management 501 manages information such as the device ID, the device type, and the device attributes of the smart device 101, manages the device registered in a space, and contains basic characteristic information, such as the resolution and screen size of the device used for learning by the user. The device profile management 501 is mapped to the content characteristic profile management 503 to assist in the distribution of the content to the device to be used by the user for learning. In addition, the device profile management 501 manages personal device registration information used by the user in the same network, and in the case in which there is a new device, the device profile management 501 does not simply register the device, but transmits an authentication request to managers such as parents at home or a teacher in school in order to restrict the registration of the device.

The user learning pattern management profile 502 reflects the result of the user learning state, determined by the learning situation recognition unit 300, and contains daily and weekly personal learning pattern information about the user. This functions to manage the life habits of the user and content related to the analysis of the user's learning patterns while studying the content, and may manage the daily learning time, subjects, content, difficulty level, the extent of change in the learning pattern for each season and the school schedule, to be utilized as material for recommendations to enable appropriate learning.

The content characteristic profile management 503 uses metadata in the file to classify the file format, data format, content interest level, and the like, transmits the data based on the user device profile, and utilizes the data to recommend learning content. For example, the content characteristic profile management 503 broadly classifies content having a text format, such as a Word, Excel, or PDF file as ‘contentType=text’, content having a multimedia format such as an AVI or MP4 as contentType=media′, and so on, in order to assist in mapping for control of the user device 100 by the device control unit 400. Further, the content characteristic profile management 503 indicates the level of interest in the content of each learning content field such that content may be selected according to the determination result of the learning situation recognition unit 300.

The user learning history management profile 504 not only provides the learning content but also provides information for providing a management/recommendation function with respect to a non-reviewed part of the learning content which is required to be learned, by understanding the content of related reference material as well as the learning content.

The learning content providing unit 600 provides learning content corresponding to the recommended content of the learning situation recognition unit 300 or learning content requested from the device control unit 400, among a plurality of pieces of pre-stored learning content, to the user device 100. The plurality of content stored in the learning content providing unit 600 includes metadata classified according to difficulty level and category, and the recommended content is learning content reproduced subsequent to currently reproduced learning content in the user device 100. The learning content providing unit 600 introduces at least one piece of learning content corresponding to the recommended content to the user, and provides at least one piece of learning content selected by the user to the user device 100.

Each component described above may be configured to operate as at least one or more hardware or software modules to perform the operation of the present disclosure. According to an embodiment, the input information recording unit 200, the learning situation recognition unit 300, the device control unit 400, the profile management unit 500, and the learning content providing unit 600 described above may be configured as one server system for providing the education service, and the user device 100 may function as a client accessing the server system. In order for the user device 100 to be provided with the content, a related application may be installed in the user device 100. Further, various communication networks, such as a wireless communication network, the Internet, or VoIP may be used for data communication between respective components, but a description therefor will be omitted.

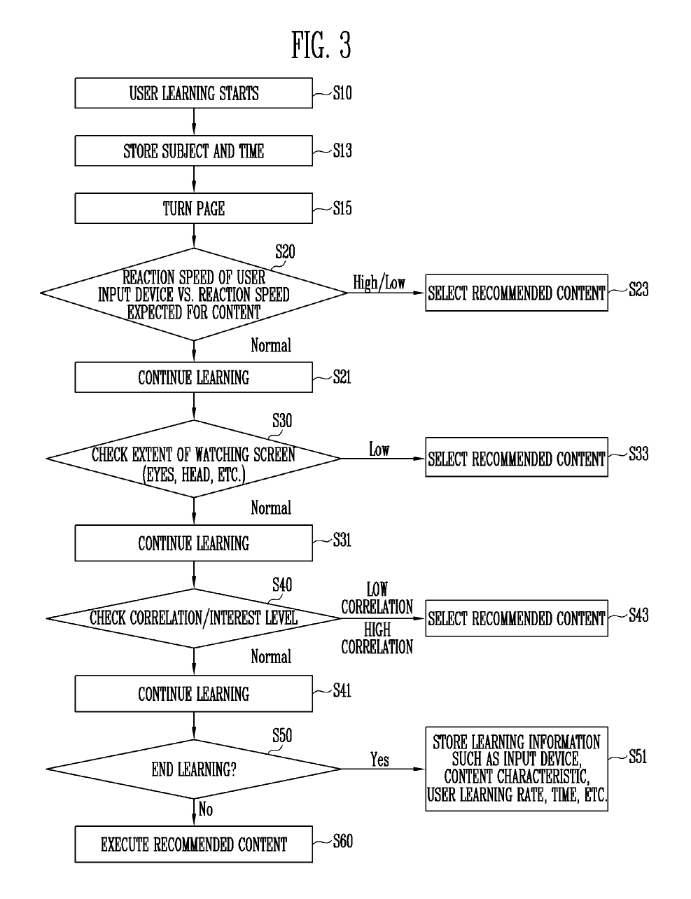

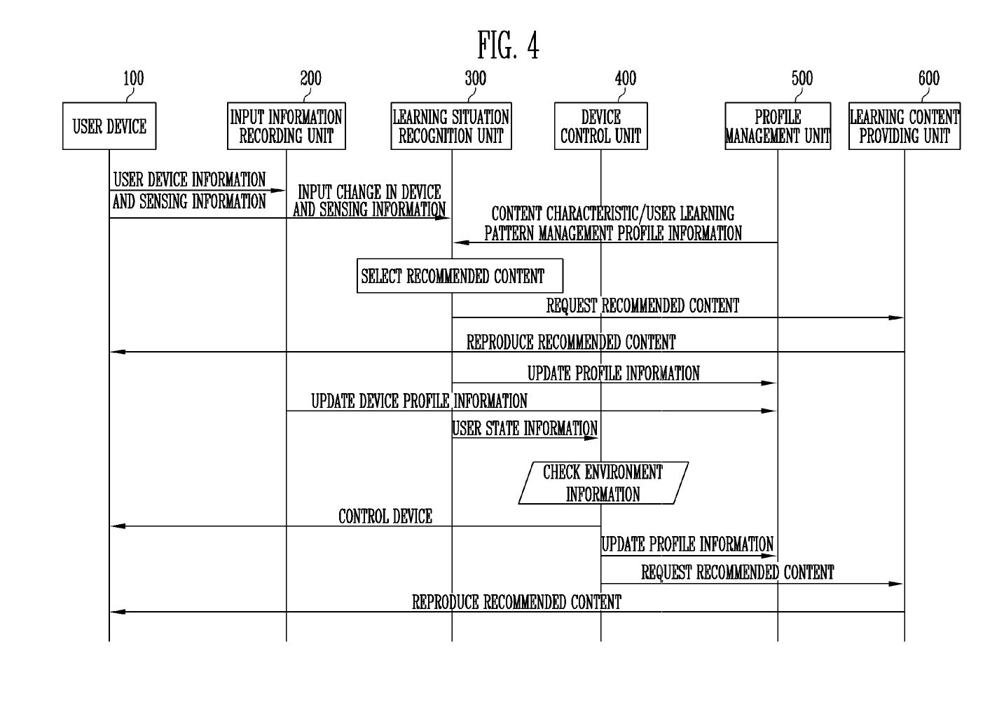

FIGS. 3 and 4 are control flowcharts of the education service system according to an embodiment of the present disclosure.

Referring to FIGS. 3 and 4, the user device 100 executes the learning content provided from the learning content providing unit 600 to start the education of the user (S10). For example, the user device 100 may include an IPTV, a desktop computer, a notebook computer, a tablet PC, and a smartphone, each including a display unit, an imaging unit, and a user interface unit.

The content characteristic of the learning content, for example, the subject and time, are stored in the profile management unit 500 (S13). The profile management unit 500 records and updates profile information on content characteristics, the content preference of the user, the learning history of the user, and device operation.

During the reproduction of the learning content, when the user turns a page of the content, device input information is generated (S15). In this case, the input information recording unit 200 collects the device input information and the sensing information at the time of reproducing the learning content. For example, the input information may be processed such that the learning situation recognition unit 300 may make a determination on the user state information based on the difference between the time at which the user is prompted by the content to make an input and the time at which the user makes an input through the mouse of the user device 100 when the learning content starts.

The reaction speed of the user at the time of reproducing the content and a preset reaction speed, expected for the content, are compared with each other (S20). Here, the reaction speed expected by the content may be calculated through an experimental/statistical method that is set in advance. Hereinafter, the reaction speed expected by the content will be referred to as a reference range.

In S20, when the reaction speed of the user is within the reference range, the currently reproduced learning content is continued to be reproduced (S21). The learning situation recognition unit 300 may continue to reproduce learning content having the same learning difficulty level as that of the currently reproduced learning content.

In S20, when the reaction speed of the user falls outside of the reference range, new recommended content is selected (S23). In detail, the learning situation recognition unit 300 may select learning content having a higher difficulty level than that of the currently reproduced learning content as the recommended content when the reaction speed of the user is above the reference range. Further, the learning situation recognition unit 300 may select learning content having a lower difficulty level than that of the currently reproduced learning content as the recommended content when the reaction speed of the user is below the reference range.

The learning situation recognition unit 300 checks the extent to which the user watches the screen based on sensing information (S30). The user device 100 includes the imaging unit, and may calculate the extent of watching the screen by analyzing the image information, imaged using the imaging unit. To this end, a related application may be installed in the user device 100 in advance.

In S30, when the extent to which the user watches the screen is in a normal state, that is, is above a reference value, the currently reproduced learning content is continued to be reproduced (S31). The learning situation recognition unit 300 may continue to reproduce learning content in the same category as that of the currently reproduced learning content. Here, the reference value of the extent to which the user watches the screen may be calculated based on an experimental/statistical method, which is set in advance.

In S30, when the extent to which the user watches the screen is below the reference value, learning content in a different category from that of the currently reproduced learning content is selected as the recommended content (S33).

The recommended content may be selected by determining the correlation between the learning content and the content preference (interest level) of the user (S40). The learning situation recognition unit 300 may select learning content having a high correlation with the learning content and a high content preference of the user as the recommended content with reference to the profile information stored in the profile management unit 500.

In S40, when the correlation of the learning content and the content preference of the user are in a normal state, for example, when the currently reproduced learning content has a high correlation with the learning content and the content preference of the user is above the reference value, the currently reproduced learning content is continued to be reproduced (S41).

In S40, the learning situation recognition unit 300 may select learning content having a low correlation and higher content preference as the recommended content with reference to the profile information stored in the profile management unit 500.

For example, the learning situation recognition unit 300 acquires information on whether the content that the user is learning has characteristic information, such as the interest level, difficulty level, data format, and the like, similar to that of the content previously learned by the user, checks the user learning pattern for the corresponding content, and compares the frequency of motion of the user while studying, the response time for the content, and the like with the input information recording unit 200 to update the user learning pattern management profile 502 when the user is in the optimal learning state and transmit the current state information to the device control unit 400 when the user is not in the optimal learning state, thereby enabling control appropriate for the situation.

Meanwhile, when the currently reproduced learning content ends or the user manually makes a selection to end the learning, the profile information is updated to that point in time (S51). When the learning content moves to the subsequent step or the user inputs an instruction to execute the recommended content, the recommended content, pre-selected in S23, S33, and S43, is executed (S60).

Although the spirit of the present disclosure has been described in detail with reference to the preferred embodiments, it should be understood that the preferred embodiments are provided to explain, but do not limit the spirit of the present disclosure. Further, a person having ordinary skill in the art to which the present disclosure pertains can understand that various modifications can be made within the scope of the technical spirit of the present disclosure.

What is claimed is:

1. An education service system comprising:
a user device reproducing a provided learning content and generating device input information through a user input;
a learning situation recognition unit calculating user state information based on the device input information and selecting a recommended content depending on the user state information; and
a learning content providing unit providing a learning content corresponding to the recommended content from among a plurality of pieces of pre-stored learning content to the user device.

2. The education service system according to claim 1, wherein the user state information includes a reaction speed of a user with respect to a response/selection speed and a pace of learning the learning content.

3. The education service system according to claim 2, wherein the plurality of pieces of content includes metadata classified depending on a learning difficulty level and a category, and the recommended content is a learning content reproduced subsequent to a currently reproduced learning content in the user device.

4. The education service system according to claim 3, wherein the learning situation recognition unit continues to reproduce the currently reproduced learning content or a learning content having the same learning difficulty level as that of the currently reproduced learning content when the reaction speed of the user is within a reference range, selects a learning content having a higher difficulty level than that of the currently reproduced learning content as the recommended content when the reaction speed of the user is above the reference range, and selects a learning content having a lower difficulty level than that of the currently reproduced learning content as the recommended content when the reaction speed of the user is below the reference range.

5. The education service system according to claim 4, wherein the learning content providing unit introduces at least one piece of learning content corresponding to the recommended content to the user and provides at least one piece of learning content selected by the user to the user device.

6. The education service system according to claim 1, further comprising:
an input information recording unit in which the device input information and sensing information at a time of reproducing the learning content are collected,
wherein the user device includes a sensing device outputting the sensing information relating to an environment surrounding the user.

7. The education service system according to claim 6, wherein the learning situation recognition unit calculates the user state information based on the device input information and the sensing information and selects the recommended content corresponding to the user state information.

8. The education service system according to claim 1, wherein the user device includes an imaging unit and the user state information further includes an extent to which a user watches a screen, determined using the imaging unit.

9. The education service system according to claim 8, wherein the learning situation recognition unit continues to reproduce a currently reproduced learning content or a learning content in the same category as that of the currently reproduced learning content when the extent to which the user watches the screen is above a reference value, and selects a learning content in a different category from that of the currently reproduced learning content as the recommended content when the extent to which the user watches the screen is below the reference value.

10. The education service system according to claim 9, further comprising:
a device control unit controlling a reality device to execute a reality-check operation for attracting attention of a user when the extent to which the user watches the screen is below the reference value,
wherein the user device includes the reality device for stimulating the user.

11. The education service system according to claim 10, wherein the reality-check operation is an operation of generating at least one of moving images providing a warning, sound, wind, and vibration.

12. The education service system according to claim 10, wherein the device control unit requests the learning content providing unit to stop providing the currently reproduced learning content and provide the recommended content when the reaction speed of the user is below the reference range or when the extent to which the user watches the screen is below the reference value.

13. The education service system according to claim 1, further comprising:
a profile management unit recording and updating profile information on content characteristics, content preference of a user, a learning history of the user, and device operation.

14. The education service system according to claim 13, wherein the learning situation recognition unit selects a learning content having a high correlation with the learning content and high content preference of the user as the recommended content with reference to the profile information at a time of selecting the recommended content.

15. The education service system according to claim 1, wherein the user device includes a smart device including a display unit, an imaging unit, and a user interface unit, respectively.

16. The education service system according to claim 6, wherein the sensing device includes at least one of a temperature sensor, a humidity sensor, an illuminance sensor, an infrared ray (IR) sensor, a magnetic sensor, a weight sensor, and a voice recognition sensor which are provided near the user.

17. The education service system according to claim 10, wherein the reality device includes an electric fan, provided near the user, and a smartphone.
